(19) United States
(12) Patent Application Publication
(10) Pub. No.: US 2016/0186899 A1
(43) Pub. Date: Jun. 30, 2016

(54) TUBULAR CONNECTION WITH SELF-LOCKING THREAD FORM USED IN THE OIL INDUSTRY

(71) Applicants: Vallourec Oil and Gas France, Aulnoye-Aymeries (FR); Nippon Steel & Sumitomo Metal Corporation, Chiyoda-ku (JP)

(72) Inventor: Jean-Guillaume BESSE, Houston, TX (US)

(73) Assignees: Vallourec Oil and Gas France, Aulnoye-Aymeries (FR); Nippon Steel & Sumitomo Metal Corporation, Chiyoda-ku (JP)

(21) Appl. No.: 14/587,899

(22) Filed: Dec. 31, 2014

(51) Int. Cl. F16L 15/06; E21B 17/043

(52) U.S. Cl. CPC F16L 15/06; E21B 17/043; F16L 2201/40

(57) ABSTRACT

A threaded connection has at least one male end threaded zone, and one female end threaded zone. A tooth width of the male threaded zone, CWTₚ, increases from CWTₚmin to CWTₚmax for the tooth closest to, and furthest from the terminal surface of the male end. A tooth width CWT_{b} of the female threaded zone decreases from CWT_{b}max to CWT_{b}min for the tooth furthest from, and closest to, the terminal surface of the female end. At least one portion of the female threaded zone and at least one portion of the male threaded zone cooperate in accordance with self-locking make-up, with

$$\frac{{CWT}_{p} min}{{CWT}_{b} max} \geq 0.2 , \\ \frac{{CWT}_{b} min}{{CWT}_{p} max} \leq \frac{{CWT}_{p} min}{{CWT}_{b} max} , \\ {CWR}_{p} max \leq 3 {CWR}_{p} min , and$$

$${CWR}_{b} max \leq 3 {CWR}_{b} min .$$

### CROSS-REFERENCE TO RELATED APPLICATIONS

This application is related to U.S. application Ser. No. 10/558,410, issued as U.S. Pat. No. 7,661,728, on Feb. 16, 2010, the entire content of which is incorporated in the present document by reference, and to U.S. application Ser. No. 13/139,522, filed on Aug. 5, 2011, the entire content of which is incorporated in the present document by reference.

### BACKGROUND

The present disclosure relates to a threaded tubular connection comprising a male tubular element comprising a male threading and female tubular element comprising a female threading which cooperates by makeup with said male threading.

The axial width of the threads of said threading and valleys between said threads vary progressively along the axis of the connection over at least a portion of the axial length of the threadings, such that the threads of each threading are housed with an axial clearance in the valleys of the other threading at the start of makeup, said clearance progressively decreasing until it becomes zero during makeup.

Threaded connections of this type generally have threads with a dovetail profile, the production of which is time consuming and costly. In addition, as the main advantage of such threaded connections is to provide superior torsional resistance, they are likely to be run into long laterals or used for drilling-with-casing or casing-while-drilling applications where higher level of torques are required. However, the increased level of stress due to torque may lead to a reduced fatigue performance which is an issue since those applications also require to maintain the sealability performance after several hours of rotation.

### SUMMARY

A threaded connection with a first and a second tubular component, each being provided with a respective male and female end. The male end comprises on its external peripheral surface at least one threaded zone, and finishes in a terminal surface which is oriented radially with respect to the axis of the connection. The female end comprises on its internal peripheral surface at least one threaded zone, and finishes in a terminal surface which is oriented radially with respect to the axis of the connection.

A width of the teeth of the male threaded zone, CWTₚ, increases from a value CWTₚmin corresponding to the width of the tooth which is closest to the terminal surface of the male end to a value CWT_{b}max corresponding to the width of the tooth which is furthest from said terminal surface. The width of the valleys of the male threaded zone, CWRₚ, increases from a value CWRₚmin corresponding to the width of the valley which is furthest to the terminal surface of the male end to a value CWRₚmax corresponding to the width of the valley which is closest from said terminal surface.

A width of the teeth of the female threaded zone, CWT_{b}, decreases from a value CWT_{b}max corresponding to the width of the tooth which is furthest from the terminal surface of the female end to a value CWT_{b}min corresponding to the width of the tooth which is closest to said terminal surface. The width of the valleys CWR_{b} of the female threaded zone decreases from a value CWR_{b}max corresponding to the width of the valley which is closest from the terminal surface of the female end to a value CWR_{b}min corresponding to the width of the valley which is furthest to the terminal surface of the female end, such that at least one portion of the threaded zones cooperate in accordance with self-locking make-up.

The maximum width (CWTₚmax, CWT_{b}max) and the minimum width (CWTₚmin, CWT_{b}min) of the teeth of the male and the female threads are configured such that:

$$\frac{{CWT}_{p} min}{{CWT}_{b} max} \geq 0.2$$

$$and$$

$$\frac{{CWT}_{b} min}{{CWT}_{p} max} \leq \frac{{CWT}_{p} min}{{CWT}_{b} max}$$

The maximum width CWRₚmax and the minimum width CWRₚmin of the valleys of the male threads are configured such that CWRₚmax≦3 CWRₚmin.

The maximum width CWR_{b}max and the minimum width CWR_{b}min of the valleys of the female threads are configured such that CWR_{b}max≦3 CWR_{b}min.

### BRIEF DESCRIPTION OF THE DRAWINGS

The characteristics and advantages of an exemplary embodiment are set out in more detail in the following description, made with reference to the accompanying drawings.

FIG. 1 depicts a diagrammatic view of a conventional connection comprising a self-locking thread form;

FIG. 2 depicts a diagrammatic view of a conventional connection comprising a self-locking thread form;

FIG. 3 depicts a detailed view of a conventional male end of a tubular component of a connection comprising a self-locking thread form;

FIG. 4 depicts a detailed view of a conventional female end of a tubular component of a connection comprising a self-locking thread form;

FIG. 5 depicts a schematic cross-sectional view of an exemplary embodiment;

FIG. 6 depicts a schematic representation of a run-out groove portion in an exemplary embodiment;

FIG. 7 depicts a detailed view of a male end of a tubular component of a connection in an exemplary embodiment;

FIG. 8 depicts a detailed view of a female end of a tubular component of a connection in an exemplary embodiment;

FIG. 9 depicts a detailed view of two, male and female, threaded zones of a connection cooperating in self-locking interference in an exemplary embodiment;

FIG. 10 depicts a detailed view of the sealing zones according to an exemplary embodiment;

FIG. 11 depicts a schematic representation of a taper line configuration for an exemplary embodiment;

FIGS. 12A-C depict a schematic representation of exemplary embodiments of a run-out;

FIG. 13 depicts a schematic representation of an insert and a run-out groove in an exemplary embodiment;

FIG. 14 depicts a schematic cross-sectional view of a second variant of an exemplary embodiment; and

FIGS. 15A-B and 16A-B depict levels of stress concentration in the exemplary embodiments of FIGS. 12A and 12C.

### DETAILED DESCRIPTION

It is an object and feature of an exemplary embodiment described herein to provide a threaded tubular connection with a male tubular component and female tubular component and a thread geometry that meets the material properties requirements and provides a sealed contact. The threaded tubular connection can be made of steel. The mechanical properties of steel, i.e., yield strength, tensile strength, ductility, and the like make steel a preferred material for the threaded tubular connection. The term sealed contact used in the present disclosure means contact between two surfaces pressed hard against each other to produce a metal-to-metal seal, in particular a gas-tight seal. An exemplary embodiment increases the stiffness of the connection and improves the fatigue behaviour of the connection.

These and other objects, advantages, and features of the exemplary threaded tubular connection described herein will be apparent to one skilled in the art from a consideration of this specification, including the attached drawings.

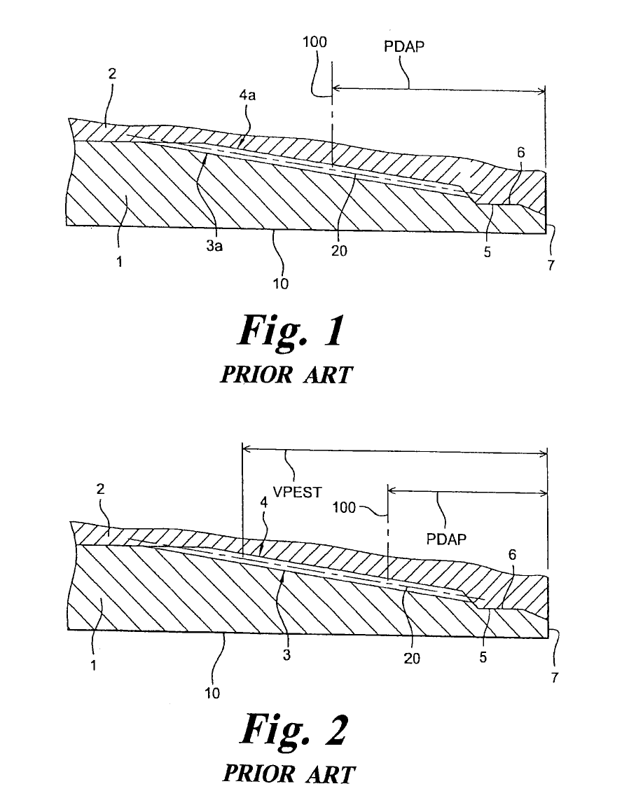

Elements of a conventional tubular connection are shown in FIGS. 1-4. FIG. 1 illustrates a conventional threaded tubular connection that includes a tubular element with a male end 1 and a tubular element with a female end 2. Each end includes respective tapered threaded zones 3a, 4a which cooperate together for mutual connection by make-up of the two elements. The threaded zones 3a, 4a are of a “self-locking” type, which may have a progressive variation of the axial width of the threads and/or the valleys between the threads, such that a progressive axial interference fit is achieved during make-up and into a final locking position.

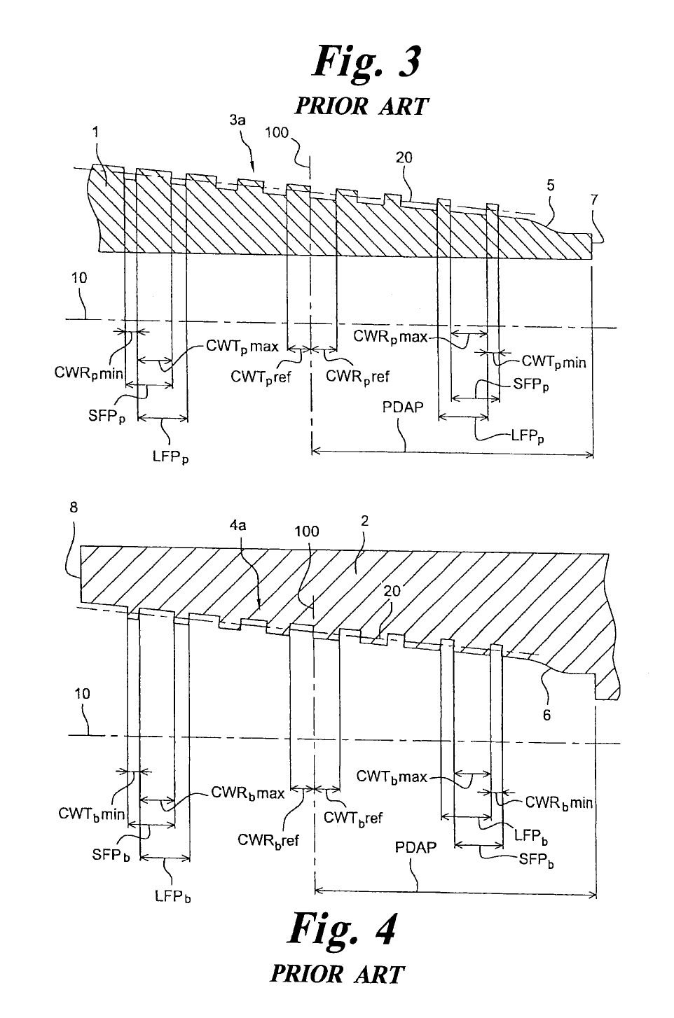

FIG. 2 illustrates a distance VPEST (Virtual Positioning End of Self-locking Thread) that is defined from a terminal surface 7, wherein VPEST is the point from which constant width threads begin. FIG. 2 further illustrates a distance PDAP (Pitch Diameter Axial Position) wherein the width of the male tooth and a female tooth are equal. The concept of PDAP is further illustrated in FIGS. 3 and 4.

As shown in FIGS. 3 and 4, the threaded zones 3a and 4a of a conventional tubular connection have a plane of symmetry 100 that is located at the distance PDAP from the terminal surface 7 of the male end. In this plane of symmetry 100, the width of the male tooth, CWTₚref, and the width of the female tooth, CWT_{b}ref, adjacent to the plane of symmetry 100 are equal.

As shown in FIGS. 3 and 4 with a longitudinal sectional view of the male end 1 and a longitudinal sectional view of the female end 2 of the conventional tubular connection, respectively, the width CWTₚmin of the tooth (or thread) located closest to the terminal surface 7 of the male end 1 is the smallest value of the whole male threaded zone 3a and also corresponds to the width of the valley CWRₚmin located furthest from said terminal surface 7.

Similarly, as shown in FIGS. 3 and 4, in the conventional tubular connection, the width CWT_{b}min of the tooth (or thread) located closest to the terminal surface 8 of the female end 2 is the smallest value of the whole female threaded zone 4a and also corresponds to the width of the valley CWR_{b}min located furthest from said terminal surface 8. In order to obtain a radial interference fit of the threaded zones, the width CWTₚmin of the narrowest tooth of the male threaded zone 3a is equal to the width CWR_{b}min of the narrowest valley of the female threaded zone 4a.

In the conventional tubular connection as shown in FIGS. 3 and 4, the narrowest teeth of the male threaded zone 3a and female threaded zone 4a are respectively clamped between the corresponding teeth which are the widest. The narrow width of the teeth close to the terminal surface of the male and female ends as well as the large width of the teeth which clamp them may separately or in combination produce a risk of deterioration by shear of these narrow teeth.

A risk of shear is higher for the tooth with the minimum width CWTₚmin located on the male end 1 than for the tooth with the minimum width CWT_{b}min located on the female end 2 since the male threaded zone 3a is imperfect close to the male teeth which clamp the minimum width tooth CWT_{b}min. Near the tooth with a minimum width CWT_{b}min, the corresponding male teeth are of reduced height to allow a transition to the non-threaded portions and thus run a much lesser risk of causing the corresponding female teeth to fail.

For a connection resulting from collar between a long tubular component carrying the male end 1 and a short tubular component (termed a collar) carrying the female end 2, for the male end 1 the teeth are more imperfect close to the transition with the non-threaded portions. A risk that the male teeth will clamp the tooth with a minimum width CWT_{b}min on the female end is small.

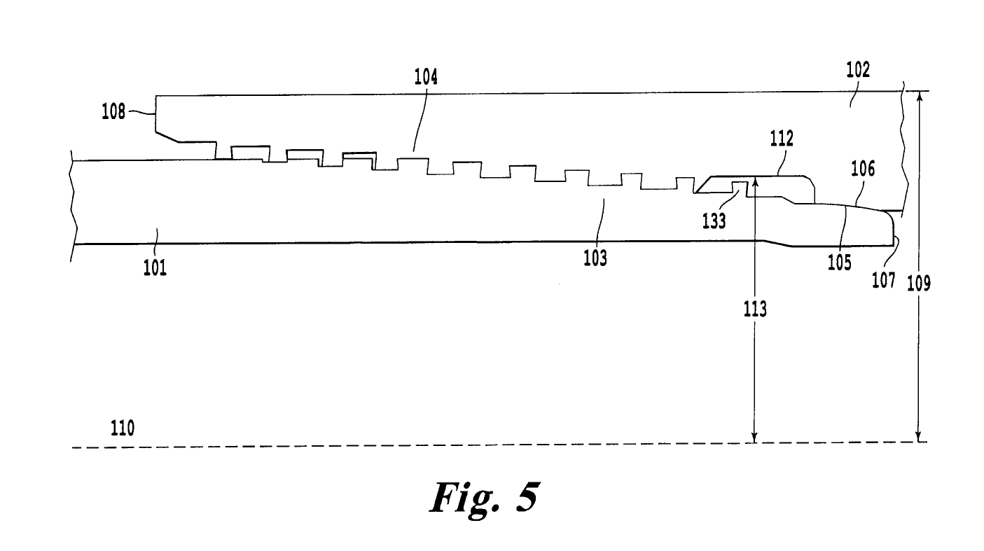

FIG. 5 illustrates a non-limiting embodiment of a tubular connection system in accordance with the present disclosure. The tubular connection system includes a male tubular element 101, and a female tubular element 102, including a threaded male element 103, and a threaded female element 104, respectively. Alternatively, the present disclosure can also be applied to a three piece tubular connection with a collar.

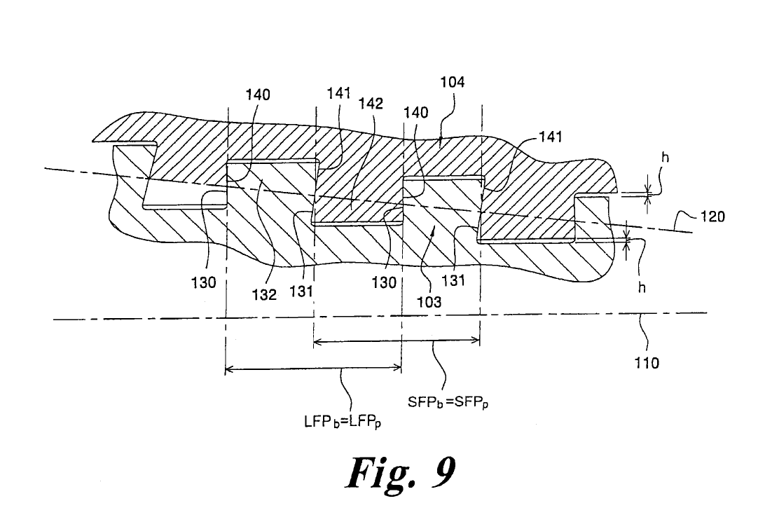

In a non-limiting exemplary embodiment shown in FIG. 5, the threaded male element 103 can include a male helical screw thread with a male crest, a male root, a male free end 107, a male stabbing flank, and a male loading flank. The male free end 107 can be a flat surface perpendicular to an axis of the threaded connection, as depicted in the non-limiting example of FIG. 5. In an exemplary embodiment, the threaded female element 104 can cooperate by makeup with the threaded male element 103. The threaded female element 104 can include a female helical screw thread with a female crest, a female root, a female free end 108, a female stabbing flank, and a female loading flank. The female free end 108 can be a flat surface perpendicular to the axis of the threaded connection, as depicted in the non-limiting example of FIG. 5. These elements are discussed in further detail later in the disclosure, for example, see the description accompanying FIG. 9.

As shown in the exemplary embodiment of FIG. 5, the female tubular element 102, also known as the box element, includes a run-out groove 112, located between the threaded female element 104, and the main portion of the female tubular element 102. The run-out groove 112 can have an inner diameter which is greater than the outer diameter of the closest engaged thread. In other words, an inner diameter of the run-out groove is greater than an outer diameter of a last engaged tooth diameter. In an exemplary embodiment, a critical cross-section of the tubular connection system is a cross-section of the run-out groove. The critical cross-section is a cross-sectional area which undergoes full tension transferred across all threads and which is located, in this embodiment, at the terminal end 107 of the tubular male element 101.

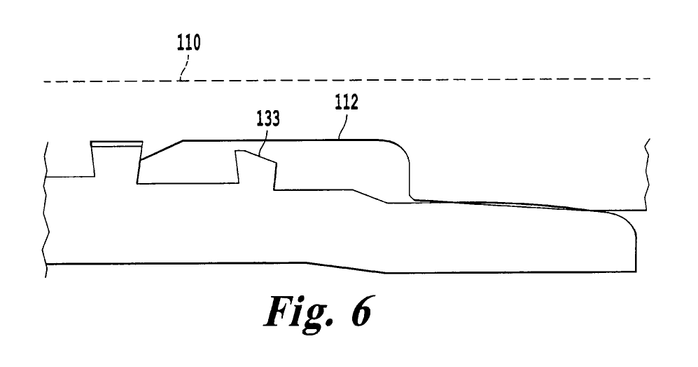

FIG. 6 illustrates a non-limiting embodiment, in which the threaded male element 103 includes a male tooth 133 present in the box run-out groove 112. Alternatively, a female tooth (not shown), instead of a male tooth 133, can be present in the box run-out groove 112. In either embodiment, there is a radial gap between the run-out groove 112 and the tooth. FIGS. 5 and 6 illustrate a non-limiting example of the radial gap between the run-out groove 112 and the male tooth 133. In alternative embodiments, additional teeth can be added in the run-out groove 112.

FIG. 7 illustrates an exemplary embodiment where the threads of the threaded female element 104 and threaded male element 103 can interlock as non-fully-locking threads. Non-fully locking threads can have an axial width of the threads of the male threading and the threads of the female threading and valleys between the threads which vary progressively along an axis of the connection 110 over at least a portion of an axial length of the threaded male element 103 and the threaded female element 104.

The threaded male element 103 can have a threaded portion with male threads separated by grooves, with width of the grooves CWRₚ increase from a value CWRₚmin corresponding to a width of the groove which is furthest from a terminal surface 107 of the threaded male element 103, to a value CWRₚmax corresponding to a width of the groove which is closest to the terminal surface 107 of the threaded male element 103.

The threaded female element 104, can have a threaded portion with female threads or grooves, with a width of a groove CWR_{b} which increases from a value CWR_{b}min corresponding to a width of the groove which is furthest from a terminal surface 108 of the threaded female element 104, to a value CWR_{b}max corresponding to a width of the groove which is closest to the terminal surface 108 of the threaded female element 104.

In alternative embodiments, another type of thread may be used instead of non-fully-locking threads.

In an exemplary embodiment, the male end 107, also known as the pin end, includes a non-locking run-out, such that the makeup of the threaded male element 103 and threaded female element 104 are not limited by any axial abutment surface. In other words, the male free end 107 does not abut the female tubular element and the female free end 108 does not abut the male tubular element. In an alternative embodiment, the additional tooth 133 and the run-out groove 112 are present but the makeup of the threaded male element 103 and threaded female element 104 are limited by at least one axial abutment surface. In other words, at make-up between the threaded male element 103 and the threaded female element 104 at least one thread of the male threaded end is located in the run-out groove 112, and this at least one thread is not in contact with the threaded female element.

In the exemplary embodiments shown in FIGS. 5-16, the geometry of both the male tubular element and the female tubular element, and their respective threaded portions, may be modified.

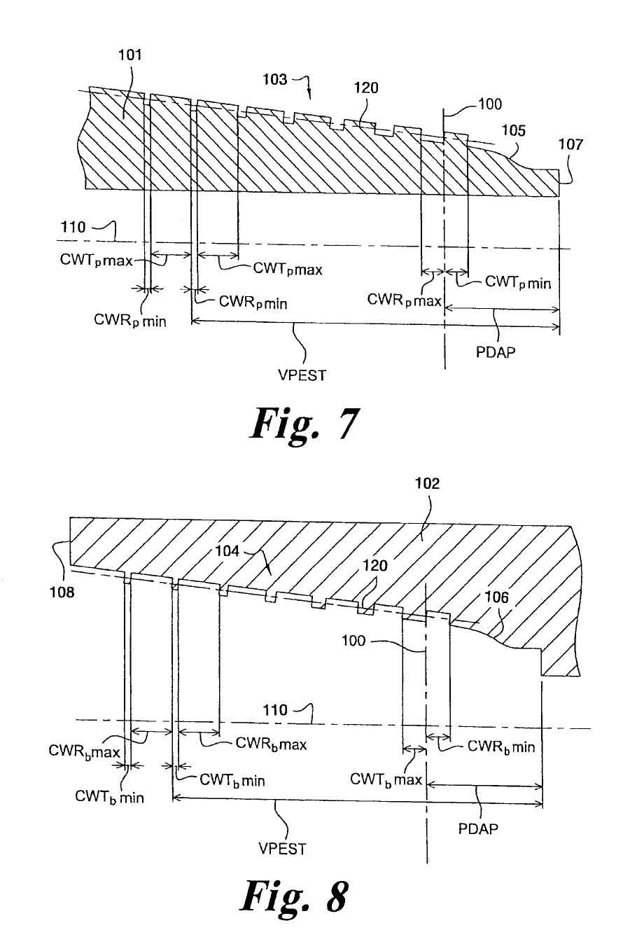

As shown in the exemplary embodiment of FIG. 7, the threaded male element 103 cooperates with the threaded female element 104 with a standard length and pitch, shown respectively in FIG. 8. In this exemplary embodiment, the ratio between the width, CWTₚmin, of the tooth of the male end closest to the terminal surface 107 of the male end 101 and the width, CWT_{b}max, of the tooth of the female end furthest from the terminal surface 108 of the female end 102 is selected to be 0.2 or more. The following equation is obtained:

$$\frac{{CWT}_{p} min}{{CWT}_{b} max} \geq 0.2 \qquad [ Equation \#1 ]$$

In an exemplary embodiment, as the ratio of CWTₚmin over CWT_{b}max approaches 1, a resistance of the connection to alternating tensile/compressive stresses is improved.

In an exemplary embodiment, a portion of the threaded male element 103 where the teeth are narrowest is reduced, resulting in the terminal surface 107 of the male end 101 being closer to the axis of symmetry 100 than when the portion of the threaded male element 103 where the teeth are narrowest is not reduced. Thus, the width of the tooth closest to the terminal surface 107 is increased by attributing to it a value approaching CWTₚref which corresponds to the width of the tooth adjacent to the axis of symmetry 100 prior to reducing the portion of the threaded male element 103 where the teeth are narrowest. For this reason, the distance PDAP is reduced, which corresponds to the distance between the axis of symmetry 100 and the terminal surface 107.

In an exemplary embodiment, in order to maintain the total length of the threaded elements and maintain clamping torque, the threaded element of the end opposite of the terminal surface 107 is extended. For this reason, the ratio between the width CWT_{b}min of the tooth of the female end 102 closest to the terminal surface 108 of the female end 102 and the width CWTₚmax of the tooth of the male end 101 furthest from the terminal surface 107 of the male end 101 is reduced, relative to a conventional tubular connection. This is expressed by the following:

$$\frac{{CWT}_{b} min}{{CWT}_{p} max} \leq \frac{{CWT}_{p} min}{{CWT}_{b} max} \qquad [ Equation \#2 ]$$

In an exemplary embodiment, the disproportion between the width CWT_{b}min of the tooth of the female end 102 closest to the terminal surface 108 of the female end 102 and the width CWTₚmax of the tooth of the male end 101 furthest from the terminal surface 107 of the male end 101 can be accentuated. In an exemplary embodiment, the teeth of the male end 101 in this region can include a chamfer which attenuates the risk of shear for the teeth of the corresponding female end 102.

In an exemplary embodiment which maintains a standard total length of a connection, opposite the terminal surface 107 of the male end 101, the width of the valleys is significantly lower than the value CWRₚmin corresponding to the minimum width of the valleys in a standard connection. To conserve a given length of the threaded zone and conserve the value of the pitch between the load flanks and between the stabbing flanks, and to avoid a width CWRₚmin so small that the cutting tools used break during passage thereof, the male threaded element 103 can be modified. In an exemplary embodiment, the male threaded element 103 is modified when the width of the valleys of the threaded male element 103 reaches a threshold value CWRₚthreshold. In an exemplary embodiment, the threaded male element 103 can be modified to have the value, CWRₚthreshold, of 0.7 or more times the tooth height.

In an exemplary embodiment, when the width of the valleys of the threaded male element 103 reaches a threshold value CWRₚthreshold, the threaded male element 103 adopts a profile in which one or more of teeth furthest from the terminal surface 107 are vanishing.

In an exemplary embodiment, to avoid a large thread portion in which the teeth of the threaded male element 3 no longer fit with radial interference, the distances VPEST and PDAP must be greater than a minimum value. In other words, to maintain a length of self-locking thread form required to guarantee a given make-up torque value, the ratio CWTₚmin/CWT_{b}max must not be increased by too much, as otherwise it would be necessary to extend the portion of the threaded male element 103 in which the width of the valleys CWRₚ is subjected to the value CWRₚthreshold.

In an exemplary embodiment, the ratio CWTₚmin/CWT_{b}max is in a range between 0.3 to 0.7.

In an exemplary embodiment, for a threaded zone with a total length of 117 mm, it is advantageous to place PDAP at a distance of 50 mm from the terminal surface 107 with values for CWTₚmin and CWT_{b}max of 2.7 mm and 5.3 mm, i.e. a ratio of 0.51. The distance at which the profile of the threaded male element 103 becomes constant is at a distance VPEST of 98 mm. The interference torque is maintained at 26000 ft lbs (35000 N m) for a 5½″ 23.00 lbs/ft T95 collar, this is done without yielding the thread.

As shown in the exemplary embodiment of FIG. 9, male threads 132 and female threads 142 (or teeth) can have a dovetail profile such that they are solidly fitted into each other after make-up. This avoids the risk of jump-out, which corresponds to the male threads 132 and female threads 142 coming apart when the connection is subjected to large bending or tensile stresses. More precisely, the geometry of the dovetail threads increases the radial rigidity of their collar compared with threads which are usually termed “trapezoidal” threads wherein the axial width reduces from the base to the crest of the threads.

The term “self-locking threaded zones” means threaded zones comprising the characteristics detailed below. As shown in the exemplary embodiment of FIG. 9, the male threads (or teeth) 132, like the female threads (or teeth) 142, have a constant pitch although their width decreases in the direction of their respective terminal surface 107, 108 such that during make-up, the male threads 132 and female threads 142 (or teeth) finish by locking into each other in a predetermined position. More precisely, the pitch LFP_{b} between the load flanks 140 of the threaded female element 104 is constant, like the pitch SFP_{b} between the stabbing flanks 141 of the threaded female element 104, with the feature that the pitch between the load flanks 140 is greater than the pitch between the stabbing flanks 141. Similarly, the pitch SFPₚ between the male stabbing flanks 131 is constant, like the pitch LFPₚ between the male load flanks 130. Further, the respective pitches SFPₚ and SFP_{b} between the male stabbing flanks 131 and female stabbing flanks 141 are equal and smaller than the respective pitches LFPₚ and LFP_{b} between the male load flanks 130 and female load flanks 140, which are themselves equal.

As shown in the exemplary embodiment of FIG. 9, the threaded male element 103 and threaded female element 104 are oriented in a taper generatrix 120 to facilitate the progress of make-up. The taper generatrix 102 is defined as passing through the center of the load flanks. In an non-limiting exemplary embodiment, the taper generatrix 120 forms an angle with the axis 110 which is in the range is between 1 degree to 5 degrees.

As shown in the exemplary embodiment of FIG. 9, contact is principally between the male load flanks 130 and female load flanks 140, and between the male stabbing flanks 131 and female stabbing flanks 141. In contrast, a clearance h may be produced between the male thread crests and the female thread roots, and similarly a clearance may be provided between the male thread roots and the female thread crests in order to facilitate the progress of make-up and prevent any risk of galling.

As shown in the exemplary embodiment of FIG. 9, the crests of the teeth and the roots of the valleys of the threaded male element 103 and threaded female element 104 can be parallel to the axis 110 of the threaded connection. In an exemplary embodiment, this configuration can facilitate machining.

In an exemplary embodiment, a fluid seal is provided by two sealing zones 105, 106 located near the terminal surface 107 of the male element 101, prevents leaks from the interior of the tubular connection to the external medium, and prevents leaks from the external medium into the tubular connection.

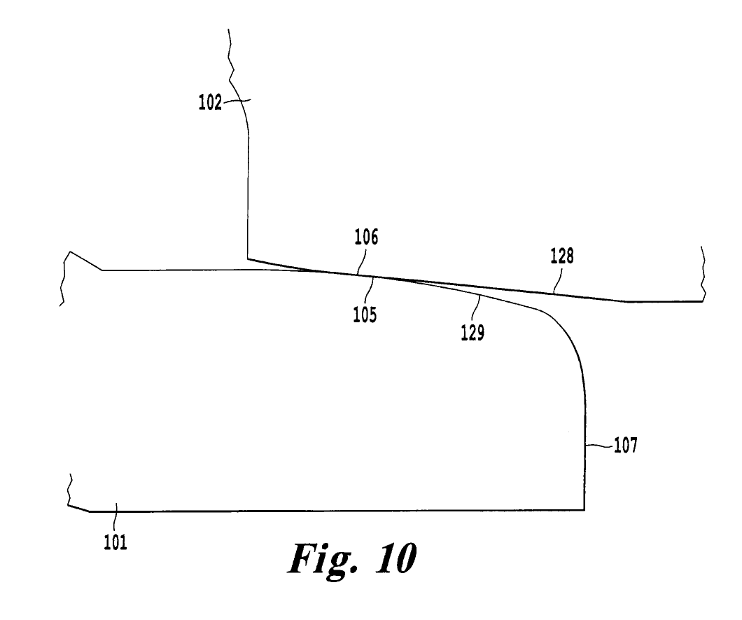

In an exemplary embodiment, as shown in FIG. 10, sealing zone 105 of the male end 101 may have a domed surface 129 which is facing radially outwardly with a diameter which decreases towards the terminal surface 107. In an exemplary embodiment, the radius of this domed surface 129 is preferably smaller than 150 mm to avoid issues associated with cone-on-cone contact. In another exemplary embodiment, the radius of the domed surface 129 is greater than 30 mm to provide a sufficient contact area. In an exemplary embodiment, the radius of this domed surface 129 is preferably in the range 30 to 100 mm.

In an exemplary embodiment, as shown in FIG. 10, opposite the domed surface, the sealing zone 106 of the female end 102 has a tapered surface 128 which faces radially inwardly with a diameter which decreases in the direction of the terminal surface 107 of the male element 101. The tangent of the peak half angle of the tapered surface 128 is in the range 0.025 to 0.075, i.e. a taper in the range 5% to 15%. In an exemplary embodiment, the taper is at least 5% to reduce the risk of galling on make-up. In an exemplary embodiment, the taper is at most 15% to avoid issues associated with close tolerances for machining.

The inventors have discovered that a contact zone between a tapered surface and a domed surface can produce a large effective axial contact width and a substantially parabolic distribution of contact pressures along the effective contact zone, in contrast to contact zones between two tapered surfaces which have narrow effective contact zones at the ends of the contact zone.

In an exemplary embodiment, with the domed surface and the tapered surface, a geometry for the contact zone can provide an effective contact width despite variations in the axial positioning of the coupled elements due to machining tolerances, the effective contact zone pivoting along the domed part of the domed surface, conserving a parabolic profile for the local contact pressure.

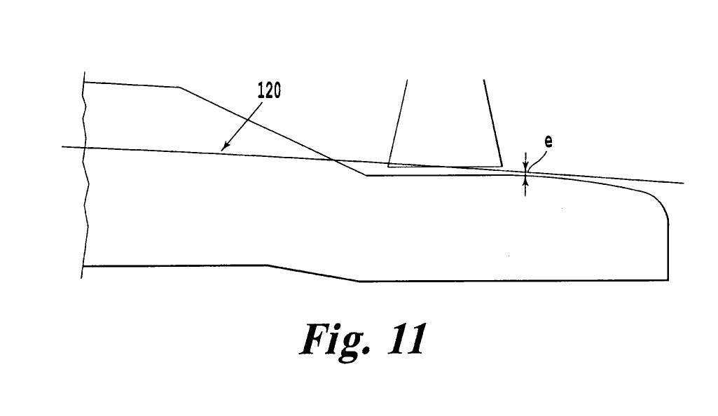

As shown in the exemplary embodiment of FIG. 11, the pin seal is configured below the taper line 120 defined by the pin root thread, with a gap e. In this embodiment, the seal radial location is configured to be below the thread taper line. This taper line configuration allows straight-running, i.e. initial positioning of inserts without plunging into the thread, for multiple teeth inserts. In a preferred embodiment the taper line has a slope between 5% and 25%, and the gap e is between 0.25 mm and 1 mm. In an alternative embodiment, the seal radial location is configured above the thread taper line, and to use an insert with multiple teeth, the length of the pin end is increased with respect to the length of the pin end when using an insert with a single tooth.

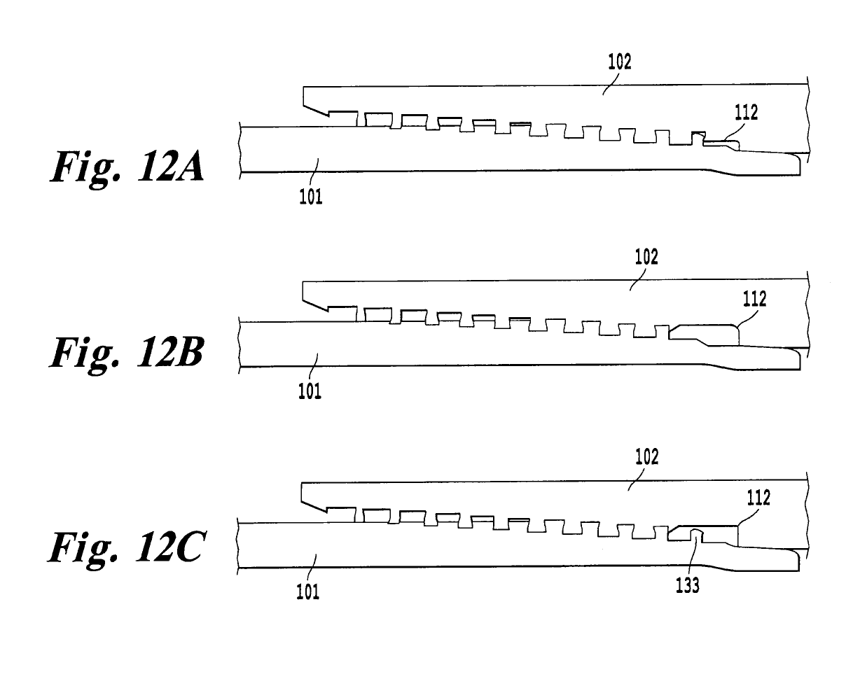

FIG. 12A shows an exemplary embodiment with a standard run-out. FIG. 12B shows an exemplary embodiment with a wider run-out, and FIG. 12C shows an exemplary embodiment with a wider run-out and an additional tooth 133. FIG. 6 shows a detailed view of the exemplary embodiment of FIG. 12C.

In the exemplary embodiment of FIG. 12A the run-out is not compatible with a two teeth insert, and machining time may be longer than machining time for the exemplary embodiments of FIG. 12B or 12C.

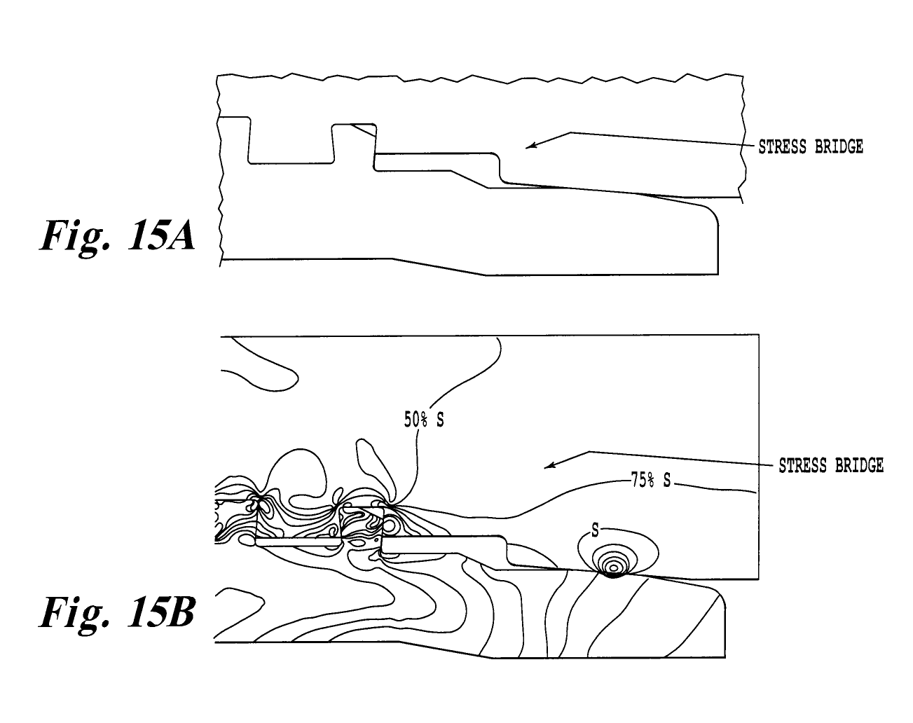

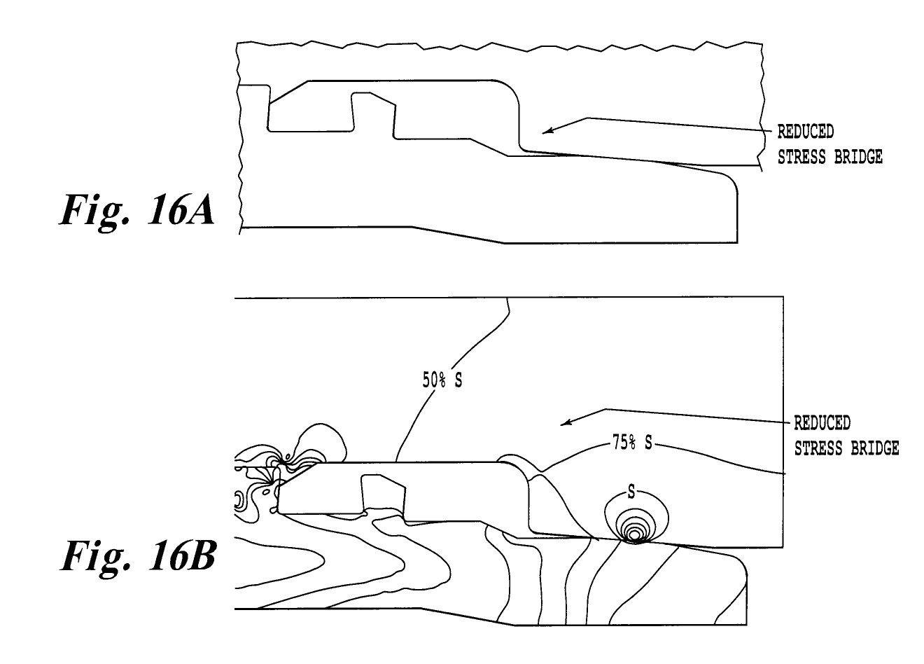

With respect to the expected sealing performance calculated through finite element analysis, the exemplary embodiment of FIG. 12C may provide less contact pressure than the exemplary embodiment of FIG. 12A but can yield 10 to 30% more contact pressure than the exemplary embodiment of FIG. 12B. The exemplary embodiment of FIG. 12C reduces the stress bridge which is present between the critical cross section and the seal area in the exemplary embodiment of FIG. 12A, as shown in FIGS. 15A-B and 16A-B. In an exemplary embodiment, the load flanks of the thread connect to the thread crest and to the adjacent thread root by roundings such that these roundings reduce the stress concentration factor at the foot of the load flanks and thereby improve the fatigue behavior of the connection. The exemplary embodiment of FIG. 12C reduces stress concentrations at the root of the first engaged pin thread. In fatigue tests carried out, the exemplary embodiment of FIG. 12C showed a survivability SAF of substantially 1.15 compared to DNV-B1 in air. In an exemplary embodiment, an insert with multiple teeth is used to reduce machining time by increasing the pass depth. An insert with two teeth can machine threads twice as fast as an insert with one tooth by removing twice as much as an insert with one tooth in the same amount of time. Machining is not negatively impacted by this configuration but is actually improved.

In an exemplary embodiment, a run-out groove 112 provides a space for lubricating fluid to escape, and a means to avoid pressure build-up. In an exemplary embodiment, the inner diameter of the run-out groove 112 is greater than the diameter of the made-up teeth adjacent to the run-out groove 112, such that with the presence of the run-out groove 112 the critical cross-section for the tubular assembly is no longer present at a location where the tubular elements contain threads. Instead, with the presence of the run-out groove 112, the critical cross-section for the tubular assembly is located at the run-out groove 112, i.e. in a non-threaded portion of the box component, effectively reducing the impact of fatigue on the component teeth. In an exemplary embodiment, the width of the run-out groove is at least 1.5 to 2 times the loading flank pitch to allow the insert to be removed from the threads after machining. In an exemplary embodiment, a width of the run-out groove 112 is configured to be at least

$$L F {P}_{b} + ( I C W - ( L F {P}_{b} - S F {P}_{b} ) ) + ( L F H + L F {P}_{b} \frac{TT}{2} ) tan {15}^{°} \qquad [ Equation \#3 ]$$

where LFP_{b} is the loading flank pitch, ICW is an insert crest width, SFP_{b} is the stabbing flank pitch, LFH is the loading flank height, and TT is the taper line angle. The 15° angle is defined relative to a plane 111 perpendicular to the axis of connection 110, as illustrated in FIG. 13.

In an alternative embodiment, as shown in FIG. 6, the additional tooth present in the run-out groove is not fully formed. In a preferred embodiment, the additional tooth in the run-out groove has a height of at least half the height of the fully formed tooth closest to the end of the tubular element.

The presence of this additional thread 133 yields a better stress distribution along the pin, and increases pin lip stiffness under external pressure application, as compared to an embodiment without the additional thread, but similar in all other aspects. As mentioned above, the exemplary embodiment shown in FIG. 12C and in FIGS. 16A-B present an improved stress distribution relative to the exemplary embodiment shown in FIG. 12A and in FIGS. 15A-B. 15B and 16B illustrate the stress contours of each respective embodiment and FIG. 16B illustrates a reduced stress bridge in comparison to FIG. 15B.

In an exemplary embodiment, machining the pin end with an additional tooth requires additional machining time, but this is at least compensated by the reduction in machining time provided by the reduction in the number of middle passes carried out by the selected insert.

In an exemplary embodiment, the outside collar diameter 9, also referred to as OD, shown in the exemplary embodiment of FIG. 1, is configured such that both tension and torsion criteria are met at a critical cross-section. In an exemplary embodiment, the tubular connection system is configured such that overall stress on the tubular components does not exceed 95% of yield strength, and such that the collar offers at least 102% tensile performance, to avoid any premature fatigue issues. The minimum collar outside diameter 9 to ensure tensile efficiency is computed from the following:

$$OD \geq \sqrt{1.02 PS \frac{4}{π} + {BDG}_{max}^{2}} \qquad [ Equation \#4 ]$$

where OD is the outside diameter in millimeters, BGDₘₐₓ is the maximum box run-out groove diameter in millimeters, and PS is the pipe body section in millimeters squared.

The minimum collar outer diameter to meet the yield strength criteria is determined by selecting OD according to the following:

σ_{VM}=0.95Y_{S}≦\sqrt{σₐ²+3τ²} [Equation #5]

where σ_{VM} is the Von Mises equivalent stress, and Y_{S} is the yield strength of the material, σₐ is the principal axial stress under tension, and τ is the shear stress generated by torque on the outside of the collar.

The selected collar outside diameter 9 value is the largest value obtained from the above tensile efficiency and yield strength criteria, which ensures that the collar diameter meets both tension and torsion criteria.

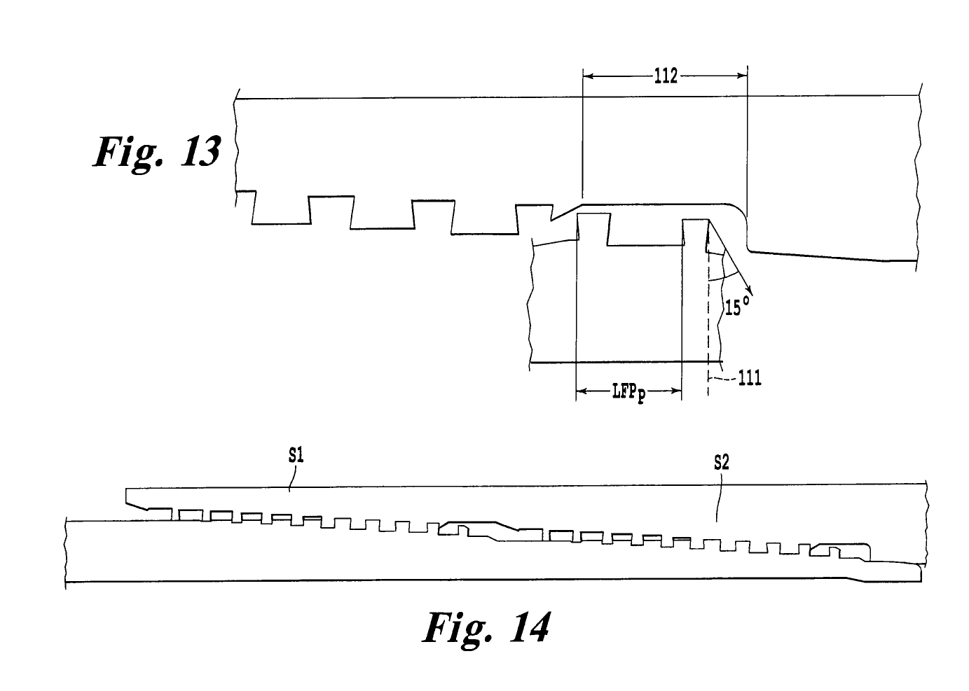

In another exemplary embodiment, as shown in FIG. 14, a tubular connection system can include two steps S1, S2. Accordingly, the first step S1 includes a threaded connection portion between the male and female tubular elements, a run-out groove, and an additional tooth on the male tubular element which is located within the run-out groove. The second step S2 includes a second threaded connection portion between the male and female tubular elements, with a second run-out groove, and an additional tooth on the male tubular element, which is located within the second run-out groove. The second step S2 also includes a metal-to-metal sealed contact portion. In this exemplary embodiment, the two steps provide a double metal-to-metal sealed contact. In an exemplary embodiment, a two-step tubular connection system can be used for integral joints or thick pipes for which a secondary seal may be useful.

Because many possible embodiments may be made of the present disclosure without departing from the scope thereof, it is to be understood that all matter herein set forth or shown in the accompanying drawings is to be interpreted as illustrative and not in a limiting sense.

1: A threaded connection comprising:
a first and a second tubular component, with a respective male and female end,
the male end including, on an external peripheral surface, at least one threaded zone and finishing in a terminal surface oriented radially with respect to an axis of the connection,
the female end including, on an internal peripheral surface, at least one threaded zone and finishing in a terminal surface oriented radially with respect to the axis of the connection,
wherein a width of the teeth of the male threaded zone, CWTₚ, increases from a value CWTₚmin of a width of a tooth closest to the terminal surface of the male end to a value CWTₚmax of a width of a tooth furthest from the terminal surface of the male end, and a width of valleys of the male threaded zone, CWRₚ, increases from a value CWRₚmin of a width of a valley furthest from the terminal surface of the male end to a value CWRₚmax of a width of a valley closest from said terminal surface,
wherein a width of the teeth of the female threaded zone, CWT_{b}, decreases from a value CWT_{b}max of a width of a tooth furthest from the terminal surface of the female end to a value CWT_{b}min of a width of a tooth closest to the terminal surface of the female end (8), and a width of valleys of the female threaded zone, CWR_{b}, decreases from a value CWR_{b}max of a width of a valley closest to the terminal surface of the female end to a value CWR_{b}min of a width of a valley furthest from the terminal surface, and
wherein at least one portion of the at least one threaded zone on the male end, and at least one portion of the at least one threaded zone on the female end cooperate in accordance with self-locking make-up, with
$$\frac{{CWT}_{p} min}{{CWT}_{b} max} \geq 0.2 , \\ \frac{{CWT}_{b} min}{{CWT}_{p} max} \leq \frac{{CWT}_{p} min}{{CWT}_{b} max} , \\ {CWR}_{p} max \leq 3 {CWR}_{p} min , and$$
$${CWR}_{b} max \leq 3 {CWR}_{b} min .$$

2. A threaded connection according to claim 1, wherein the ratio between the width, CWTₚmin, of the tooth closest to the terminal surface of the male end and the width, CWT_{b}max, of the tooth furthest from the terminal surface of the female end is in the range 0.3 to 0.7.

3. A threaded connection according to claim 1, wherein at make-up at least the male threading tooth closest to the terminal surface is located in a run-out groove provided on the female end.

4. A threaded connection according to claim 3, wherein an inner diameter of the run-out groove is greater than an outer diameter of a last engaged tooth diameter, such that a critical cross-section of the connection system is a cross-section of the run-out groove.

5. A threaded connection according to claim 3, wherein a width of the run-out groove is configured to be at least 1.5 greater than a loading flank pitch.

6. A threaded connection according to claim 3, wherein a width of the run-out groove is configured to be at least:
$$L F {P}_{b} + ( I C W - ( L F {P}_{b} - S F {P}_{b} ) ) + ( L F H + L F {P}_{b} \frac{TT}{2} ) tan {15}^{°}$$
where LFP is a loading flank pitch, ICW is an insert crest width, SFP is a stabbing flank pitch, LFH is a loading flank height, and TT is a taper line angle.

7. A threaded connection according to claim 1, wherein an outside collar diameter is configured based on both tension and torsion criteria at a critical cross-section.

8. A threaded connection according to claim 1, wherein at least a tooth furthest from a terminal surface is a vanishing tooth.

9. A threaded connection according to claim 8, wherein at least a male threading tooth furthest from the terminal surface of the male end is a vanishing tooth.

10. A threaded connection according to claim 1, wherein the male and female threaded zones have a taper generatrix forming an angle with the axis of the connection in a range between 1 degree and 5 degrees.

11. A threaded connection according to claim 1, wherein teeth of the male and female threaded zones have a dovetail profile.

12. A threaded connection according to claim 1, wherein crests of the teeth and roots of the valleys of the male and female threaded zones are parallel to the axis of the threaded connection.

13. A threaded connection according to claim 1, wherein a clearance h is provided between crests of the teeth of the male threaded zone and roots of the valleys of the female threaded zone.

14. A threaded connection according to claim 1, wherein at least one of the male and female ends comprises a first sealing surface to cooperate in interfering contact with a second sealing surface on at least one of the male and female ends when the threaded zones cooperate following self-locking make-up.

15. A threaded connection according to claim 14, wherein at least one sealing surface is axially spaced from the terminal surface of the male end by at least 3 millimeters.

16. A threaded connection according to claim 15, wherein the first and second sealing surfaces are respectively constituted by a domed surface on one and by a tapered surface on the other.

17. A threaded connection according to claim 16, wherein the domed surface has a generatrix with a radius of curvature in a range of 30 to 100 mm.

18. A threaded connection according to claim 16, wherein a tangent of a peak half-angle of the tapered surface is in a range of 0.025 to 0.075 mm.

19. A threaded connection according to claim 14, wherein a cooperation zone in interfering contact of the sealing surfaces is located below a taper line of the threaded zone of the male end.

20. A threaded connection according to claim 6, wherein the taper line angle is in a range between 5 degrees and 25 degrees.
